(19) United States
(12) Patent Application Publication
(10) Pub. No.: US 2022/0035956 A1
(43) Pub. Date: Feb. 3, 2022

(54) PASSWORD-BASED ACCESS CONTROL FOR PROGRAMMABLE LOGIC DEVICES

(71) Applicant: HEWLETT PACKARD ENTERPRISE DEVELOPMENT LP, Houston, TX (US)

(72) Inventors: Stephen R. Porter, Houston, TX (US); Gennadiy Rozenberg, Houston, TX (US); Yendri Karina Gonzalez Rodriguez, Heredia (CR); Luis Federico Li Chang, Heredia (CR); Jhovel Louie L. Lopez, Roseville, CA (US)

(21) Appl. No.: 16/942,941

(22) Filed: Jul. 30, 2020

(51) Int. Cl. G06F 21/79; G06F 21/74; G06F 21/85; G06F 21/46; G06F 21/73

(52) U.S. Cl. CPC G06F 21/79; G06F 21/74; G06F 2221/2141; G06F 21/46; G06F 21/73; G06F 21/85

(57) ABSTRACT

A technique includes an access controller of a programmable logic device providing password protection-based access to a memory of the programmable logic device. The programmable logic device initiates programming of the access controller with a password; and in response to the programmable logic device detecting a predetermined stimulus, the programmable logic device initiates communication of the password to the access controller to unlock access to the memory.

### BACKGROUND

A computer system may contain one or multiple programmable logic devices (PLDs). In general, a PLD is an electrical component that is contained in a semiconductor package (“or chip”) and contains logic gates. The PLD may be programmed to configure the logic gates to perform one or multiple digital functions. Some PLDs are one time programmable devices, and other PLDs, such as complex PLDs, or “CPLDs,” may be reprogrammed. As an example, a CPLD may contain a non-volatile memory, such as flash memory, that stores an image that configures the CPLD to perform its functions, and the flash memory may be reprogrammed, or “reflashed,” to replace the image for purposes of modifying and/or replacing functions of the CPLD.

### BRIEF DESCRIPTION OF THE DRAWINGS

FIG. 1 is a schematic diagram of a computer system according to an example implementation.

FIG. 2 is an illustration of an environment for a programmable logic device (PLD) of the computer system of FIG. 1 illustrating potential ways in which a memory of the PLD may be unlocked according to an example implementation.

FIG. 3 is a flow diagram depicting a process performed by a password controller of the PLD according to an example implementation.

FIGS. 4A, 4B and 4C are flow diagrams depicting processes used by the password controller to generate a password for the PLD according to example implementations.

FIG. 5 is a flow diagram depicting a process to program an access controller of a programmable logical device with a password and provide the password to the access controller according to an example implementation.

FIG. 6 is a schematic diagram of an apparatus that includes a semiconductor package, an access control circuit, and a password control circuit to program the access control circuit with a password and initiate providing the password to the access control circuit according to an example implementation.

FIG. 7 is a schematic diagram of a system that includes a programmable logic device, which includes an access controller to unlock access to a memory of the programmable logic device and a password controller to initiate programming of the access controller with a password according to an example implementation.

### DETAILED DESCRIPTION

A computer system may contain one or multiple programmable logic devices (PLDs) that may perform various functions for the computer system. A given PLD may be a trusted component of the computer system, and as such, measures may be employed to prevent the integrity of the PLD from being compromised. As a more specific example, a baseboard management controller (BMC) of a computer system may, in conjunction with a PLD (e.g., a complex programmable logic device (CPLD)), perform configuration and/or management functions for the computer system. Moreover, in accordance with example implementations, the BMC may contain a silicon root of trust (RoT) for the computer system, and as such, measures may be employed for purposes of preventing modification of the PLD by a rogue device and/or the reading of confidential or sensitive data that is stored in a memory of the PLD.

As a more specific example, in accordance with some implementations, a computer system may contain a PLD that performs one or multiple of the following functions: fault detection; providing vectors to control system component configuration that is performed by a BMC; providing general purpose input/output (GPIO) expansion for the BMC; and other functions. The data that is stored in the PLD's memory configures the PLD to perform its functions.

In general, access to the PLD's memory may be tightly controlled to prevent a rogue device from changing functions of the PLD (e.g., by reflashing the PLD's memory) and/or reading sensitive or confidential data that is stored in the PLD's memory. For example, the PLD may employ password-based access control. With this type of access control, the PLD is programmed with a password, and access to the PLD's memory is locked. The password serves as the key to unlock memory access (also referred to as “unlocking the memory” herein).

One way to provide a password to a PLD to unlock the PLD's memory is to communicate the password to the PLD using a communication protocol that is specified by the PLD's manufacturer. For example, the password may be provided to the PLD by communicating with an external bus port of the PLD, such as a test access port (e.g., a Joint Test Action Group (JTAG) bus port) of the PLD. As a more specific example, to update the PLD's memory with a new image (i.e., update the memory with a set of data configuring one or multiple functions of the PLD), the password may be provided to the PLD via the PLD's JTAG bus port using a communication protocol that is specified by the manufacturer of the PLD. In response to receiving the correct password, the PLD unlocks access to its memory, and then an operation (e.g., a reflashing operation or a read operation) may be performed via the JTAG bus port to update the PLD's memory. After the update, the PLD may then relock its memory so that for another operation, the correct password is to be provided again to unlock the memory for this other operation.

A particular challenge with the above-described way of providing a password to a PLD is that the password is communicated outside of the PLD, which introduces a potential security vulnerability. For example, it is possible that when the password is communicated to the PLD via a JTAG bus, the password or the transaction communicating the password may be snooped from the JTAG bus. A rogue device that snoops the password or password transaction may, for example, replay the snooped password or password transaction on the JTAG bus to gain unauthorized access to the PLD's memory.

In accordance with example implementations that are described herein, a PLD (e.g., a CPLD) employs measures to confine the password inside the PLD, thereby inhibiting, if not preventing, unauthorized access to and use of the password. More specifically, in accordance with example implementations, the PLD includes an internal password circuit (herein called a “password controller”), which initiates and then programs a password into an access control circuit (herein called an “access controller”) of the PLD. For example, the password controller may, in response to a first power up of the PLD (after the PLD has been placed in a production mode of operation), program the PLD with a password. When a permitted condition (or “stimulus”) occurs for memory access, the password controller responds to provide the password to the PLD's access controller. With the password programming and password communication being confined inside the PLD, the password cannot be snooped outside of the PLD, such as from, for example, a JTAG bus or other bus.

In accordance with example implementations, the PLD, in response to detecting a predetermined stimulus (corresponding to a permitted memory access), generates a trigger (e.g., a predetermined signal state), and the password controller responds to the trigger to provide the password to the access controller. For example, in accordance with some implementations, a BMC may communicate a specific command to the PLD over a secure, trusted bus (e.g., a bus in which all bus agents are trusted). The command represents that the BMC is to read or is to update the image that is stored in the PLD. In response to the receipt of the command, in accordance with example implementations, logic inside the PLD generates a trigger to prompt the PLD's password controller to provide the password to the PLD's access controller to unlock access to the PLD's memory. After the corresponding memory operation (e.g., a read operation or a reflashing operation) is performed, in accordance with example implementations, the access controller relocks the memory so that the memory cannot be accessed without another password being communicated to the access controller.

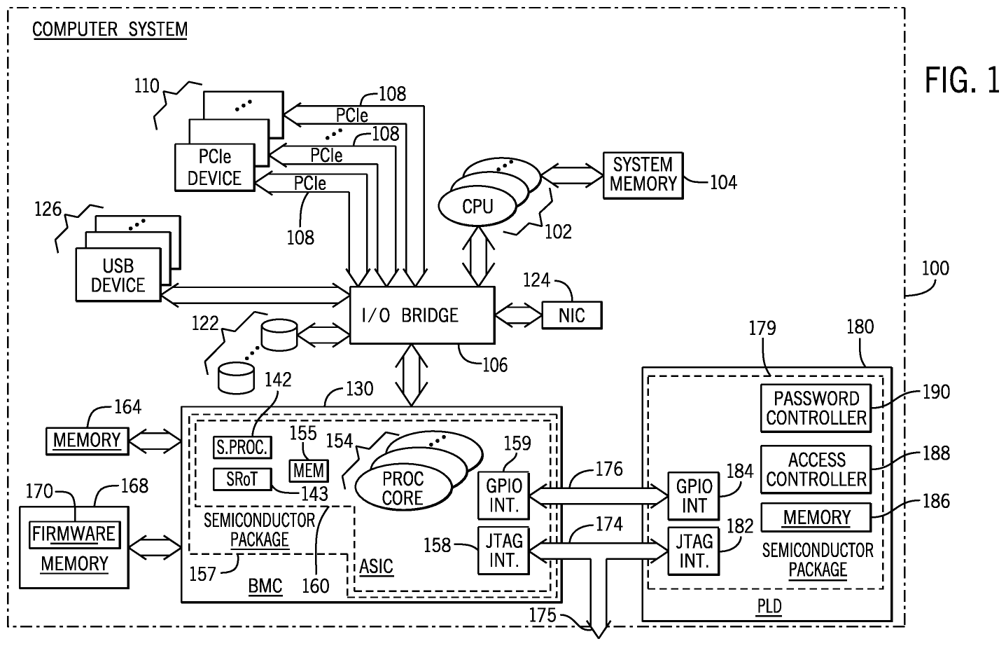

Referring to FIG. 1, as a more specific example, in accordance with some implementations, a computer system 100 includes a PLD 180 (e.g., a complex programmable logic device (CPLD), a programmable array logic (PAL) device, a field programmable gate array (FPGA) device, and so forth) to perform one or multiple functions for the computer system 100. As examples, these functions may include one or multiple of the following functions: providing vectors to a BMC 130 to guide initialization of components of the computer system 100; performing fault detection for the computer system 100; performing reset control; providing patch instructions to the BMC 130; and other functions.

In accordance with example implementations, the BMC 130 is an embedded subsystem, which may contain one or multiple semiconductor packages (or “chips”) that are mounted on one or multiple circuit substrates (e.g., printed circuit boards (PCBs)) As used herein, a “BMC,” or “baseboard management controller,” is a specialized service processor that monitors the physical state of a server or other hardware using sensors and communicates with a management system through a management network. The baseboard management controller may also communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices that are located in a server chassis including system memory. The baseboard management controller may be able to directly modify the hardware devices. The baseboard management controller may operate independently of the operating system of the system in which the baseboard management controller is disposed. The baseboard management controller may be located on the motherboard or main circuit board of the server or other device to be monitored. The fact that a baseboard management controller is mounted on a motherboard of the managed server/hardware or otherwise connected or attached to the managed server/hardware does not prevent the baseboard management controller from being considered “separate” from the server/hardware. As used herein, a baseboard management controller has management capabilities for sub-systems of a computing device, and is separate from a processing resource that executes an operating system of a computing device. The baseboard management controller is separate from a processor, such as a central processing unit, which executes a high-level operating system or hypervisor on a system.

The computer system 100 may be any of a number of computer systems, such as a server, a client, a desktop computer, a laptop computer, a rack mounted server module, a wearable computer, a tablet, a smart phone, or other computer system, depending on the particular implementation. Therefore, the architecture that is depicted in FIG. 1 may be different, in accordance with further implementations. Moreover, although example implementations are discussed herein in which a BMC 130 communicates with the PLD 180, it is understood that, in accordance with further implementations, a PLD may communicate with a component of a computer system other than a BMC.

For the example implementation that is depicted in FIG. 1, the BMC 130 includes an ASIC 160. The ASIC 160 may perform one or multiple functions for the BMC 130. In general, the BMC 130 may perform a number of functions for the computer system 100, such as monitoring the physical state of the computer system 100 and communicating with a management system through a management network. As more specific examples, the BMC 130 may monitor sensors (e.g., temperature sensors, cooling fan speed sensors); monitor operating system status; monitor power statuses; log computer system events; and provide management functions for the computer system, which may be controlled remotely. Moreover, the BMC 130 may allow operations to be performed when the computer system 100 is powered down and before the operating system has booted; and the BMC 130 may be used to perform recovery operations after an operating system or computer system failure.

In accordance with example implementations, the ASIC 160 may include one or multiple general purpose processing cores 154 that execute machine executable instructions, such as firmware, for purposes of performing one or multiple functions for the computer system 100. As depicted in FIG. 1, the ASIC 160 may be part of a semiconductor package 157. In this context, a “semiconductor package” refers to a casing, or encapsulation, which contains one or multiple integrated circuits, such as the ASIC 160. The integrated circuit(s) of the semiconductor package may be disposed on one or multiple die; and the semiconductor package may contain leads (also called “contacts,” “external contacts,” “terminals,” “external terminals,” and so forth), which allow signals, voltages, currents, and so forth to be communicated between the integrated circuit(s) of the semiconductor package and one or multiple components outside of the semiconductor package. The semiconductor package may take on one of numerous forms, such as a through-hole package, a surface mount package, a chip carrier package, a pin grid array package, a flat package, a small outline package, a chip-scale package, a ball grid array package, and so forth.

As also depicted in FIG. 1, in accordance with example implementations, the components of the PLD 180 may also be contained in a semiconductor package 179. The semiconductor package 179 may contain one or multiple die.

In accordance with example implementations, the BMC 130 and the PLD 180 may communicate using at least two buses, or communication links: a trusted bus 176 and an untrusted bus 174. As an example, the untrusted bus 174 may be a JTAG bus. As depicted in FIG. 1, the ASIC 160 may include a JTAG communication interface 158 for purposes of communicating with the untrusted bus 174 and a general purpose input/output (GPIO) interface 159 for purposes of communicating with the trusted bus 176. As depicted in FIG. 1, the PLD 180 may contain a GPIO interface 184 for purposes of communicating with the trusted bus 176 and a JTAG interface 182 (corresponding to the PLD's JTAG port) for purposes of communicating with the JTAG bus 174.

In accordance with example implementations, the JTAG bus 174 may be accessed by bus components, or agents, other than the BMC 130 and the PLD 180. For example, as illustrated in FIG. 1, a particular external bus agent may be connected to the JTAG bus 174 by an external computer system connector 175. As such, the JTAG bus 174 may be considered “untrusted,” in that unvetted, untrusted entities may potentially, via the JTAG bus 174, access the PLD 180 through the PLD's JTAG port. It is noted that during a development mode of operation for the PLD 180, which occurs in a secure environment, the JTAG bus 174 may be used for purposes of updating the PLD 180 (e.g., updating the PLD 180 through an external device that is connected to the external connector 175 through a cable dongle).

As described further herein, in accordance with example implementations, the PLD 180 includes an internal password control circuit (herein called a “password controller 190”). In accordance with example implementations, before the PLD 180 is installed in the computer system 100 (during the manufacturing of the computer system 100), the password controller 190 may be programmed, or configured, with a particular password that is to be used to control access to a memory 186 of the PLD 180. The PLD 180 may generally have two modes of operation: a development mode of operation, in which the PLD 180 may be updated and tested; and a production mode of operation in which the PLD 180 is placed in final product state (although the PLD's memory 186 may potentially be reflashed or updated over the lifetime of the PLD 180). During the initial power up of the PLD 180 after the PLD 180 is placed in the production mode of operation, in accordance with example implementations, the password controller 190 programs an internal access control circuit (herein called an “access controller 188”) of the PLD 180 with the password and configures the access controller 188 to lock access to the memory 186 (also called locking the memory 186 herein).

In accordance with example implementations, accesses cannot occur to the memory 186 when locked; the access controller 188 provides the functions of unlocking and locking the memory 186; and the access controller 188 unlocks the memory 186 in response to the access controller 188 receiving the correct password (i.e., the password programmed into the access controller 188 by the password controller 190). Moreover, in accordance with example implementations, the access controller 188 unlocks the memory 186 for a single operation (e.g., an operation to read data from the memory 186 or an operation to update the memory 186 with a new image); and after the operation is complete, the access controller 188 relocks the memory 186.

The password controller 190 may be constructed to, in accordance with example implementations, provide the password to the access controller 188 in response to logic of the PLD 180 detecting a particular stimulus that corresponds to a permitted memory access. In accordance with example implementations, one such stimuli may be provided by the BMC 130. For example, the BMC 130 may communicate a command, via the trusted bus 176, to the PLD 180, representing that the BMC 130 requests access to the memory 186. As further described herein, the PLD 180 detects the command (i.e., detects the permitted stimulus) and generates a trigger to cause the password controller 190 to provide the password to the access controller 188 to unlock the memory 186. Subsequently, the BMC 130 may communicate with the PLD 180 to access the memory 186 (e.g., communicate a new image via the untrusted bus 174) for purposes of updating the image that is stored in the memory 186.

A stimuli to trigger the password controller 190 to send the password to the access controller 188 may be produced by an entity other than the BMC 130, in accordance with example implementations. For example, in accordance with example implementations, when the PLD 180 is in the development mode of operation, the stimulus may be produced by toggling a certain external terminal of the PLD.

In accordance with example implementations, the PLD 180 may be constructed to also allow the password to be provided to the access controller 188 via the PLD's JTAG port instead of being provided by the password controller 190. Such external password transmissions may be relatively infrequent (e.g., password transmissions to update the memory 186 with a new image), as compared to the rate at which the password controller 190 internally provides the password, thereby minimizing opportunities to snoop the password.

In accordance with example implementations, the computer system 100 includes one or multiple central processing units (CPUs) 102 (e.g., CPU processing cores, semiconductor containing CPU processor cores, and so forth), and memory devices (e.g., memory modules) that are coupled to the CPU(s) 102 to form a system memory 104. The CPU(s) 102 may be coupled to an input/output (I/O) bridge 106, which allows communications between the CPU(s) and the BMC 130, as well as communications with various I/O devices, such as storage drives 122, one or multiple network interface card(s) 124, Universal Serial Bus (USB) devices 126, and so forth. Moreover, as also depicted in FIG. 1, the computer system 100 may include one or multiple Peripheral Component Interconnect Express (PCIe) devices 110 (e.g., PCIe expansion cards) that are coupled to the I/O bridge 106 through individual PCIe bus(es) 108.

The general purpose processing core(s) 154 of the BMC 130, in accordance with example implementations, may execute firmware instructions 170 that are stored in a non-volatile memory 168. In accordance with example implementations, the firmware instructions 170 include instructions that are executed by components of the computer system 100 other than the general purpose processing cores 154. In accordance with example implementations, the firmware instructions 170 include instructions that are executed by a security processor of the BMC 130 (as part of the BMC's security plane); instructions that are executed by the general processing core(s) 154 of the BMC 130 (i.e., firmware corresponding to a management firmware stack corresponding to a management plane of the BMC 130); and instructions that are executed by the CPU(s) 102 to boot the computer system 100 and provide runtime services. The computer system 100 may also include a volatile memory 164 that may be accessed and used by the BMC 130.

In general, the memory devices that form the system memory 104, the firmware memory 168 and the volatile memory 164, as well as other memory devices that are described herein, may be formed from non-transitory storage devices, such as semiconductor device-based devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices, EEPROM devices, and so forth), unless otherwise stated herein.

In general, after being powered on or reset, the BMC 130 holds its general purpose processing core(s) 154 in reset. After performing initial root of trust security checks as well as other checks (e.g., hardware fault checks), the BMC 130 releases the general purpose processing core(s) 154 from reset. In accordance with example implementations, the BMC 130 includes a hardware, silicon root-of-trust (SRoT) engine 143. In accordance with example implementations, the BMC 130 stores an immutable fingerprint, which is used by the SRoT engine 143 to validate machine executable instructions.

More specifically, in accordance with example implementations, in response to the BMC 130 being powered on or reset, the SRoT engine 143 validates and then loads an initial portion of the firmware instructions 170 into a memory 155 of the BMC 130 so that this firmware portion is now trusted. A security processor 142 of the BMC 130 is then allowed to boot and execute the loaded firmware instructions. By executing the firmware instructions, the security processor 142 may then validate another portion of the firmware instructions 170 that corresponds to a portion of the BMC's management firmware stack and after validation, load this portion of the firmware stack into the memory 155 of the BMC 130. The portion of the management firmware stack may then be executed by the general purpose processing core(s) 154, which causes the processing core(s) 154 to load additional portions of the firmware instructions 170 and place the loaded portions into the memory 164. Those instructions may be executed from the validated portion of the BMC's firmware stack in the memory 155. In accordance with example implementations, the BMC 130 may lock the memory 155 to prevent modification or tampering with the validated portion(s) stored in the memory 155.

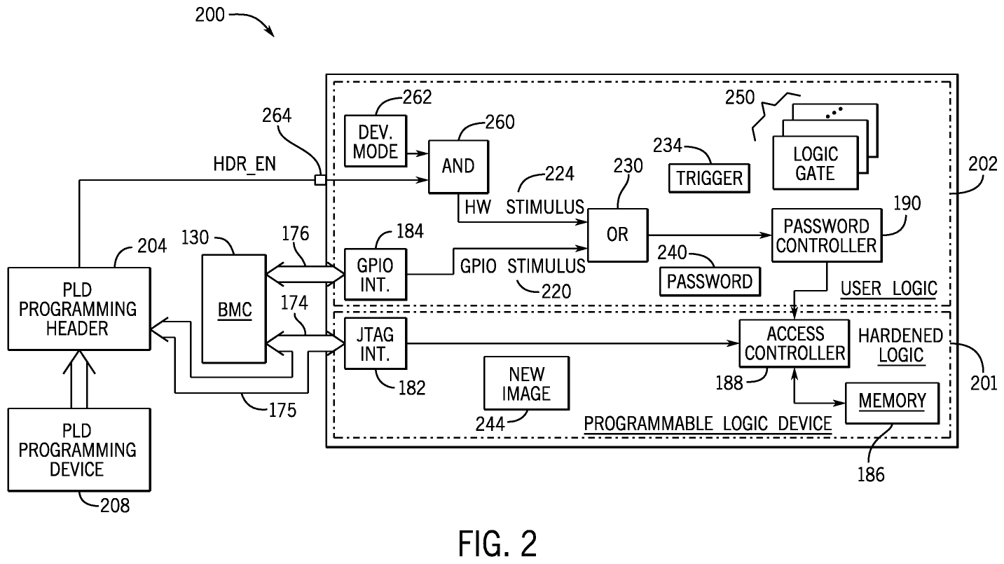

FIG. 2 is an illustration 200 of an example environment for the PLD 180, illustrating potential ways in which the PLD's memory 186 may be unlocked, in accordance with example implementations. As depicted in FIG. 2, in accordance with example implementations, the PLD 180 includes a hardened logic section 201 and a user logic section 202. In general, the hardened logic section 201 performs built-in, non-configurable functions of the PLD 180. In other words, in accordance with example implementations, the functions that are associated with the components of the hardened logic section 201 are fixed and cannot be modified, either through changes to the data stored in the memory 186, or otherwise. In accordance with example implementations, the hardened logic section 201 in its nonmodifiable form is fabricated by the manufacturer of the PLD 180. As also depicted in FIG. 2, in accordance with example implementations, the hardened logic section 201 includes the access controller 188, the memory 186 and the JTAG interface 182.

The user logic section 202, in accordance with example implementations, contains the programmable (and reprogrammable), or configurable (and reconfigurable), part of the PLD 180. In general, the memory 186 may store data that programs, or configures, the user logic section 202 to implement one or multiple functions for the PLD 180. More specifically, in accordance with example implementations, a particular image of data may be stored in the memory 186 for purposes of configuring logic gates 250 of the user logic section 202 to perform one or multiple functions for the PLD 180, creating one or multiple lookup tables (LUTs), and so forth.

As also depicted in FIG. 2, in accordance with example implementations, the user logic section 202 includes the password controller 190. In general, the password controller 190 programs the access controller 188 with a password 240, configures the access controller 188 to lock the memory 186, and in response to receiving a trigger 234 (e.g., a particular signal state) representing detection of one or multiple stimuli, provides the password 240 to the access controller 188 to unlock the memory 186. In accordance with example implementations, the password controller 190, as well as other components of the user logic section 202, may be constructed by programming the PLD 180 (e.g., via data written to a nonmodifiable part of the memory 186) such that a certain combination of logic gates 250 provide the password controller 190 and these other components. In this manner, in accordance with some implementations, Hardware Description Language (HDL) may be used to abstractly define the functions of these components and program the corresponding functions into the PLD 180. In accordance with further implementations, the password controller 190, as well as other components of the user logic section 202, may be formed by hardwired components of the PLD 180; may be formed by one or multiple processor cores executing machine executable instructions; and so forth.

FIG. 2 illustrates two example ways in which the memory 186 may be unlocked and accessed, in accordance with an example implementation. The first example way may occur when the PLD 180 is placed in a development mode of operation and may involve the use of a PLD programming device 208 that is connected to the external connector 175 of the computer system 100. For example, the PLD programming device 208 may be connected through a cable dongle to the external connector 175. In general, the PLD programming device 208 may provide a PLD programming header 204, which contains a sequence of data that represents the beginning of a transaction on the JTAG bus 174 to update an image that is stored in the memory 186. As depicted in FIG. 2, in accordance with example implementations, the presence of the PLD programming header 204 causes the assertion of a particular signal (HDR_EN) on a particular external terminal 264 of the PLD 180. In accordance with some implementations, external circuitry may be used for purposes of generating the HDR_EN signal in response to detecting the PLD programming header 204 on the JTAG bus 174. In accordance with further example implementations, external circuitry may be used to toggle a particular terminal of the PLD 180 during the development mode of operation to indicate requested programming of the PLD 180.

In accordance with some implementations, an AND gate 260 of the PLD 180 performs a logical AND of the signal state of the terminal 264 and a bit 262 indicating whether the PLD 180 is in the development mode of operation. If the PLD 180 is in the development mode of operation and the state of the terminal 264 represents a request for programming of the PLD 180, then, in accordance with example implementations, the AND gate 260 provides a hardware stimulus 224 (e.g., an asserted signal state of the AND gate 260) to an OR gate 230 of the PLD 180. The hardware stimulus 224, in turn, represents a permitted stimulus to unlock the memory 186. The hardware stimulus 224 causes an OR gate 230 of the PLD 180 to provide the trigger 234 (e.g., an asserted signal state) to the password controller 190, in accordance with example implementations.

In response to the trigger 234, in accordance with example implementations, the password controller 190 provides the password 240 to the access controller 188, which, in turn, causes the access controller 188 to unlock the memory 186. Moreover, in accordance with example implementations, after the corresponding memory operation (e.g., a read operation, a flashing operation, and so forth) has been performed, the access controller 188 relocks the memory 186.

In accordance with example implementations, a stimulus to unlock the memory 186 may be produced when the PLD 180 is in the production mode of operation (i.e., when the PLD 180 is shipped as part of a product, such as a server, for example). As an example, a particular fuse or other permanently-set bit 262 of the PLD 180 may be programmed to place the PLD 180 in the production mode of operation. In accordance with example implementations, in the production mode of operation, a stimulus may no longer be provided via the JTAG bus 174 (as discussed above) to unlock the memory 186. In other words, in accordance with example implementations, the bit 262 may be permanently de-asserted to disable the generation of the hardware stimulus 224.

In the production mode of operation, the memory 186 may be unlocked in response to the PLD 180 detecting a GPIO stimulus 220. In general, the GPIO stimulus 220 may be produced by an authorized requestor, such as the BMC 130, requesting access to the memory 186. For example, in accordance with some implementations, the GPIO interface 184 may receive a communication, via the trusted bus 176, from the BMC 130 representing that the BMC 130 requests access to the memory 186. For example, in accordance with some implementations, the BMC 130 may communicate a specific command over the trusted bus 176, such that upon receipt of this command, the GPIO interface 184 provides the GPIO stimulus 220 (e.g., asserts a signal state representing detection of the GPIO stimulus 220). The assertion of the GPIO stimulus 220, in turn, in accordance with example implementations, causes the OR gate 230 to provide the trigger 234; and the trigger 234 causes the password controller 190 to provide the password 240 to the access controller 188 to unlock the memory 186. Accordingly, the BMC 130 may then communicate data (a new image 244, for example) to the memory 186, read data from the memory 186, and so forth. After the specific memory operation is complete, in accordance with example implementations, the access controller 188 may then relock the memory 186. In accordance with further example implementations, an authorized requestor other than the BMC 130 may cause the generation of the GPIO stimulus 220.

As noted above, in accordance with example implementations, the PLD 180 may be constructed to also allow an external password to be communicated to the PLD 180 for purposes of unlocking the memory 186. For example, in accordance with some implementations, for purposes of updating the memory 186, a password may be communicated via the JTAG bus 174, and upon receipt of this password, the access controller 188 may unlock the memory 186 to allow access to the memory 186 for an operation and thereafter relock the memory 186.

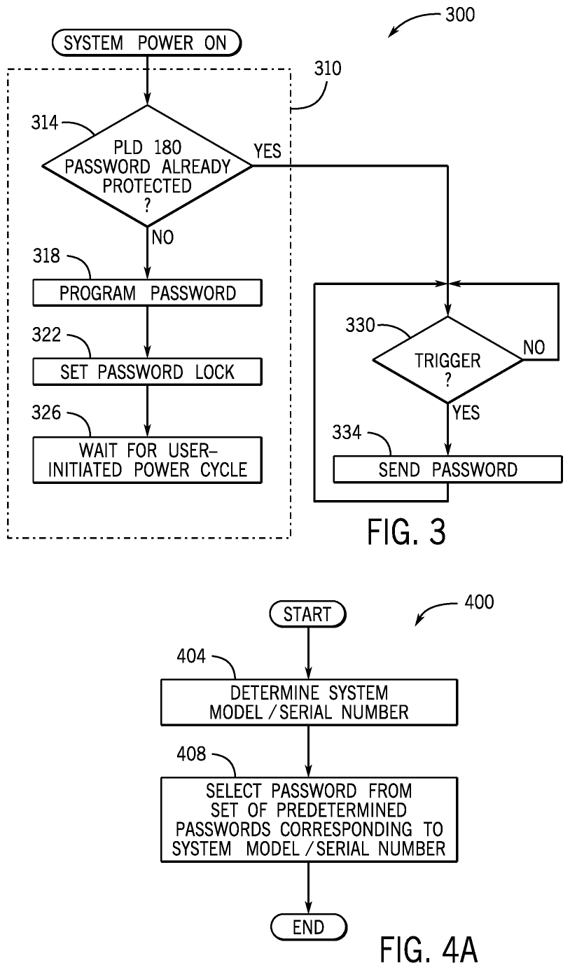

FIG. 3 depicts a process 300 that may be performed by the password controller 190, in accordance with example implementations. In some implementations, the processor controller 190 may be a finite state machine, having the following general states: a power up state, a password programming state, a stimulus detection state and a password sending state. It is noted that these particular states may have various sub-states for purposes of implementing particular programming details (e.g., programming certain registers of the access controller 188 to program the password, turn on the password lock mode of the controller 188, and so forth).

Referring to FIG. 3 in conjunction with FIGS. 1 and 2, in accordance with example implementations, upon power on of the computer system 100, the password controller 190 may initially perform actions (represented inside box 310) to assess whether or not the access controller 188 has been programmed with a password and if not, program the access controller 188 with the password. More specifically, in accordance with example implementations, the password controller 190 enters the power up state in which the password controller 190 determines (decision block 314) whether the PLD 180 has already been password protected. In accordance with some implementations, the password controller 190 determines that the PLD 180 has not been password protected based on the PLD 180 being powered up the first time after the PLD 180 was placed in the production mode of operation. Upon determining (decision block 314) that the PLD 180 has not been password protected, then, in accordance with example implementations, the password controller 190 enters the password programming state in which the password controller 190 programs (block 318) the access controller 188 with the password and sets (block 322) a password lock, i.e., configures the access controller 188 to enforce the password controlled access to the memory 186. Next, in accordance with example implementations, pursuant to block 326, the password controller 190 enters a wait sub-state to wait for another user-initiated power cycle. In other words, upon the next power cycle, control transitions from decision block 314 to decision block 330 in which the password controller 190 enters the stimulus detection state to wait for the appropriate stimulus to trigger the sending of the password.

More specifically, as depicted in FIG. 3, in accordance with example implementations, in decision block 330, the password controller 190 waits for the PLD 180 to detect a permitted stimulus, as indicated by a trigger being received by the password controller 190; and when the trigger is received, the password controller 190 transitions to the password sending state to send (block 334) the password to the access controller 188. Control then returns to the stimulus detection state in which the password controller 190 waits (decision block 330) for the next trigger.

In accordance with some implementations, the PLD 180 may be programmed with a specific, predetermined password, so that the password controller 190 provides this password to the access controller 188. Knowledge of the specific password may be tightly controlled, and such knowledge may be beneficial, for example, for purposes of providing authorized updates to the memory 186. In this manner, as discussed above, in addition to the internal initiation and sending of the password by the password controller 190, the password may also be provided, via the JTAG bus 174, to the PLD 180.

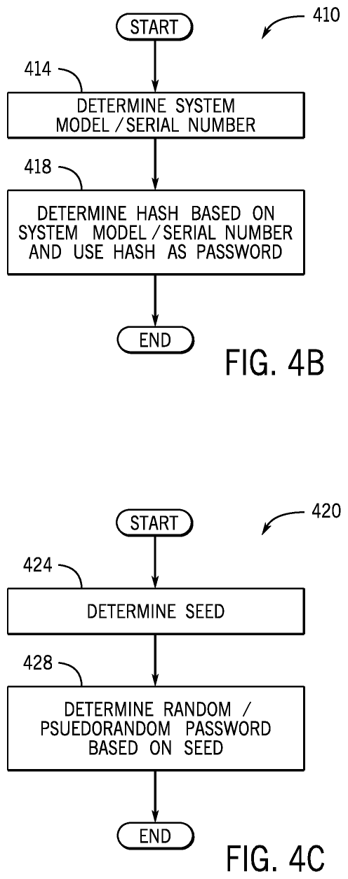

In accordance with further example implementations, the password controller 190 may generate the password based on certain criteria. For example, referring to FIG. 4A in conjunction with FIG. 2, in accordance with example implementations, the password controller 190 may perform a process 400 that includes determining (block 404) a particular identifier for the computer system 100, such as, for example, a computer system model number or a computer system serial number. From this identifier, pursuant to block 408, the password controller 190 may then select a password corresponding to the identifier. For example, in accordance with some implementations, the PLD 180 may be included in multiple versions of a particular server product, or other computer product. Passwords corresponding to these different versions may be programmed into the PLD 180 so that the password controller 190 may then select a particular password that corresponds to the model number/serial number of the product for purposes of selecting this password and providing the password to the access controller 188. If the PLD 180 is to be at some point updated via a password that is provided through communications on the JTAG bus 174, then the appropriate password may be identified based on knowledge of the serial number and/or model number of the computer system 100. Moreover, as noted above, knowledge of this password may be tightly controlled.

As another example, referring to FIG. 4B, in accordance with some implementations, pursuant to a process 410, the password controller 190 may generate a hash based on an identifier that is associated with the computer system 100, such as a system model or serial number and use this hash value (a value derived therefrom) as the password. Therefore, as depicted in FIG. 4B, a process 410 may include the password controller 190 determining a system model or serial number of the computer system, pursuant to block 414, and determining (block 418) the corresponding hash value based on the model/serial number such that the hash may be used as the password.

In this context, a “hash,” or “hash value,” refers to a value that is produced by the application of a cryptographic hash function to an input (e.g., a binary image of a given unit of code) to produce the hash. In this manner, a cryptographic hash function may be applied, or performed, by a processor executing machine-executable instructions (“software”) to receive an input and produce an output (the “hash”) that corresponds to the input. Any minute change to the input may alter the hash. As examples, the cryptographic hash function may be a signed hash function (SHA), any federal information processing standards (FIPS) approved hash function, any national institute of standards and technology (NIST) approved hash function, or any other cryptographic hash function. Moreover, in accordance with further example implementations, a cryptographic hash function may be a function that is applied, or performed, by a hardware circuit (e.g., an ASIC, a FPGA, a CPLD, and so forth) without executing machine-executable instructions.

Referring to FIG. 4C in conjunction with FIG. 2, in accordance with further example implementations, the password controller 190 may randomly or pseudorandomly generate the password. More specifically, pursuant to a process 420, the password controller 190 may determine (block 424) a seed and determine (block 428) the random or pseudorandom password based on the seed, pursuant to block 428. It is noted that, in accordance with some implementations, using this technique, the password may not be externally known outside of the PLD 180, and in accordance with example implementations, after programming the access controller 188, the password controller 190 may store the password for future use.

More specifically, in accordance with example implementations, the password controller 190 may contain a pseudorandom or random number generator to generate a number, and the password controller 190 may use this number (or a value derived therefrom) as the password. In this context, a “pseudorandom number” may be a nearly random number, and in accordance with example implementations, the password controller 190 may include a pseudorandom number generator. For example, the pseudorandom random number generator may be a seed-based generator, which provides a pseudorandom number at its output. As a more specific example, in accordance with some implementations, the password controller 190 may include a polynomial-based pseudorandom number generator. This generator provides a pseudorandom number that is based on a seed value that serves as an input to a polynomial function. As examples, the seed value may be derived from a state or condition at the time the pseudorandom number is to be generated, such as input provided by real time clock (RTC) value, a counter value, a measured noise value, a register value, and so forth. The polynomial-based generator receives the seed value as an input, applies a polynomial function to the seed value and provides an output (digital data, for example) that represents the pseudorandom number. In accordance with further example implementations, the password controller 190 may have an actual, or true, random number generator. This generator provides an output that represents a true random number, which the superior bus device communicates to a given subordinate bus device via the presence terminal-based side channel; and the superior bus device also embeds the same true random number in bus messages that are sent to the given subordinate bus device bus. As an example, the true random number generator may include an analog-to-digital converter (ADC) that provides a random digital output; and the ADC may sample a truly random analog signal, such as a thermal noise signal (a Johnson-Nyquist noise signal that is provided by a resistor, for example) or an atmospheric noise signal that is received by an antenna.

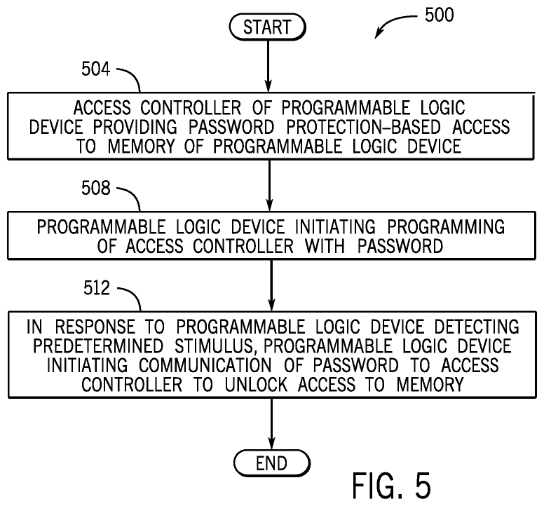

Referring to FIG. 5, in accordance with example implementations, a process 500 includes, an access controller of a programmable logic device providing (block 504) password protection-based access to a memory of the programmable logic device. The programmable logic device initiates (block 508) programming of the access controller with a password; and, pursuant to block 512, in response to the programmable logic device detecting a predetermined stimulus, the programmable logic device initiates communication of the password to the access controller to unlock access to the memory.

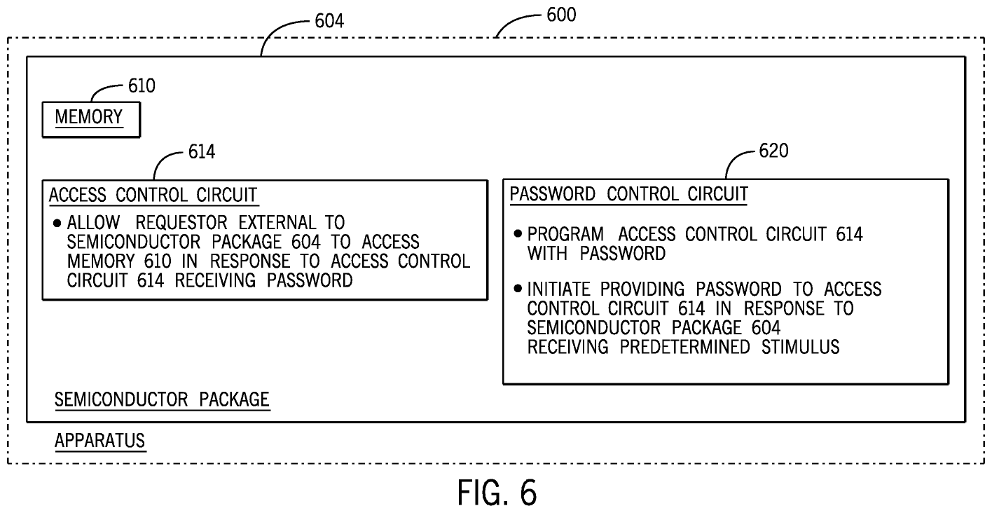

Referring to FIG. 6, an apparatus 600 includes a semiconductor package 604; a memory 610 in the semiconductor package 604; an access control circuit 614 in the semiconductor package 604; and a password control circuit 620 in the semiconductor package 604. The access control circuit 614 allows a requestor that is external to the semiconductor package 604, to access the memory 610 in response to the access control circuit 614 receiving a password. The password control circuit 620 programs the access control circuit 614 with the password, and initiates providing the password to the access control circuit 614 in response to the semiconductor package 604 receiving a predetermined stimulus.

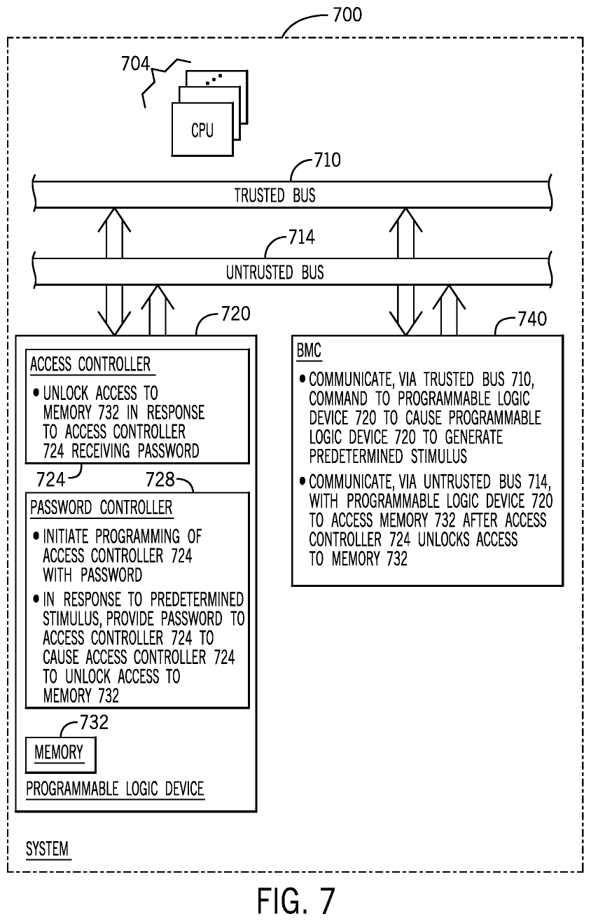

Referring to FIG. 7, in accordance with example implementations, a system 700 includes central processing units (CPUs) 704; a trusted bus 710; and untrusted bus 714; a programmable logic device 720 and a BMC 740. The programmable logic device 720 is coupled to the trusted bus 710 and is coupled to the untrusted bus 714. The programmable logic device 720 includes an access controller 724, a password controller 728 and a memory 732. The access controller 724 unlocks access to the memory 732 in response to the access controller 724 receiving a password. The password controller 728 initiates the programming of the access controller 724 with the password; and in response to a predetermined stimulus, provides the password to the access controller 724 to cause the access controller 724 to unlock access to the memory 732. The BMC 740 is coupled to the trusted bus 710 and is coupled to the untrusted bus 714. The BMC 740 communicates, via the trusted bus 710, a command to the programmable logic device 720 to generate the predetermined stimulus; and the BMC 740 communicates, via the untrusted bus 714, with the programmable logic device 720 to access the memory 732 after the access controller 724 unlocks access to the memory 732.

In accordance with example implementations, detecting the predetermined stimulus includes detecting a command that is communicated to the programmable logic device via a trusted bus. The image may be communicated to update the memory to the programmable logic device via an untrusted bus. A particular advantage is that the triggering of the update to the memory is controlled via a trusted component of the computer system, such as a BMC.

In accordance with example implementations, in response to receiving the password via an untrusted bus, the access control circuit may unlock access to the memory. A particular advantage is that the programmable logic device is able to be updated by providing the password to the programmable logic device.

In accordance with example implementations, in response to detecting the stimulus, the programmable logic device generates the password and communicates the generated password internally to the access controller. A particular advantage is that the password does not appear externally to the programmable logic device, thereby inhibiting snooping of the password or transaction containing the password.

In accordance with example implementations, detecting the predetermined stimulus includes detecting receipt of a signal at an external terminal of the programmable logic device and detecting whether the programmable logic device is in a development mode of operation. A particular advantage is that the memory of the programmable logic device may be updated during development of the programmable logic device.

In accordance with example implementations, in response to the programmable logic device being powered up, a determination is made whether the access controller has been set up for the password protection-based access control. In response to this determination, the programmable logic device may be programmed with the password. A particular advantage is that the programming of the access controller with the password is provided internally, thereby preventing snooping of the password during the programming.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
an access controller of a programmable logic device providing password protection-based access to a memory of the programmable logic device;
the programmable logic device initiating programming of the access controller with a password; and
in response to the programmable logic device detecting a predetermined stimulus, the programmable logic device initiating communication of the password to the access controller to unlock access to the memory.

2. The method of claim 1, wherein detecting the predetermined stimulus comprises detecting a command communicated to the programmable logic device via a trusted bus, the method further comprising:
communicating an image to update the memory of the programmable logic device via an untrusted bus.

3. The method of claim 1, further comprising:
in response to receiving the password via an untrusted bus, the access control circuit unlocking access to the memory.

4. The method of claim 1, further comprising:
in response to detecting the stimulus, the programmable logic device communicating the password internally to the access controller.

5. The method of claim 1, wherein detecting the predetermined stimulus comprises detecting receipt of a signal at an external terminal of the programmable logic device and detecting whether the programmable logic device is in a development mode of operation.

6. The method of claim 1, further comprising:
in response to the programmable logic device being powered up, determining whether the access controller has been set up for the password protection-based access control; and
in response to the determination, programming the access controller with the password.

7. An apparatus comprising:
a semiconductor package;
a memory in the semiconductor package;
an access control circuit in the semiconductor package to allow a requestor external to the semiconductor package to access the memory in response to the access control circuit receiving a password; and
a password control circuit in the semiconductor package to program the access control circuit with the password, and initiate providing the password to the access control circuit in response to the semiconductor package receiving a predetermined stimulus.

8. The apparatus of claim 6, wherein:
the access control circuit receives a request from the requestor to access the memory via an untrusted communication link; and
the predetermined stimulus is generated in response to a command received by the semiconductor package via a trusted communication link.

9. The apparatus of claim 8, wherein the untrusted communication link comprises a communication link corresponding to a test access port of the semiconductor package.

10. The apparatus of claim 8, wherein the trusted communication link comprises a communication link coupled to a baseboard management controller containing a root of trust.

11. The apparatus of claim 7, wherein the predetermined stimulus comprises a combination of the semiconductor package being in a development mode of operation and the semiconductor package receiving a predetermined signal at a predetermined terminal of the semiconductor package.

12. The apparatus of claim 7, wherein:
the access control circuit unlocks access to the memory to allow an update to the memory in response to receiving the password from the password control circuit; and
the access control circuit relocks access to the memory in response to completion of the update.

13. The apparatus of claim 7, wherein:
the password comprises a given candidate password of a plurality of candidate passwords; and
the password control circuit to select the given candidate password based on an identifier associated with a computer containing the semiconductor package.

14. The apparatus of claim 7, wherein the password control circuit to generate the password based on a model number or a serial number of a computer system containing the semiconductor package.

15. The apparatus of claim 7, wherein the password control circuit:
in response to being powered up, determines whether the access control circuit has been set up to enforce password protection for access to the memory; and
in response to the determination, programs the access control circuit with the password.

16. The apparatus of claim 15, wherein the access control circuit determines that the access control circuit has not been set up to enforce the password protection based on detection of a first power up of the semiconductor package after the semiconductor package has been placed in a production mode of operation.

17. A system comprising:
central processing units (CPUs);
a trusted bus;
an untrusted bus;
a programmable logic device coupled to the trusted bus and coupled to the untrusted bus, wherein:
the programmable logic device comprises an access controller, a password controller and a memory contained within a semiconductor package;
the access controller to unlock access to the memory in response to the access controller receiving a password; and
the password controller to:
initiate programming of the access controller with the password; and
in response to a predetermined stimulus, provide the password to the access controller to cause the access controller to unlock access to the memory; and
a baseboard management controller coupled to the trusted bus and the untrusted bus, wherein the baseboard management controller to:
communicate, via the trusted bus, a command to the programmable logic device to cause the programmable logic device to generate the predetermined stimulus; and
communicate, via the untrusted bus, with the programmable logic device to access the memory after the access controller unlocks access to the memory.

18. The system of claim 17, wherein the baseboard management controller communicates with the programmable logic device to access the memory to reprogram one or multiple logic functions of the programmable logic device.

19. The system of claim 17, wherein the programmable logic device is programmed to perform at least one of the following:
general purpose input/output (GPIO) expansion for the baseboard management controller;
fault detection;
reset control;
system component configuration;
vector-based selection of programmable code executed by the baseboard management controller; or
communication of patch code to the baseboard management controller.

20. The system of claim 17, wherein the password controller:
in response to being powered up, determines whether the access controller has been set up to enforce password protection for access to the memory; and
in response to the determination, programs the access controller with the password.
